(19) United States
(12) Patent Application Publication
(10) Pub. No.: US 2025/0070272 A1
(43) Pub. Date: Feb. 27, 2025

(54) RECHARGEABLE BATTERY WITH ROTATING ELECTRODE

(71) Applicant: Arthur Oded RUPPIN, Ringwood, NJ (US)

(72) Inventor: Arthur Oded RUPPIN, Ringwood, NJ (US)

(21) Appl. No.: 18/237,931

(22) Filed: Aug. 25, 2023

(51) Int. Cl. H01M 10/42; H01M 4/13; H01M 10/058

(52) U.S. Cl. CPC H01M 10/4214; H01M 4/13; H01M 10/058; H01F 7/20; H01M 2004/025

(57) ABSTRACT

A rechargeable battery including: a first electrode; a second electrode; an ion transfer medium; and an electric motor; wherein the first and second electrodes are connected by the ion transfer medium that facilitates ion movements between the first and second electrodes; and wherein the first electrode is rotatable and the electric motor is configured to rotate the first electrode during a charge operation to stimulate the movement of ions from the first electrode to the second electrode.

### FIELD

The present disclosure relates to rechargeable batteries, and more specifically to a rechargeable battery with a rotating electrode configured to stimulate the movement of charged particles between electrodes.

### BACKGROUND

A rechargeable battery is a type of electrical battery which can be charged, discharged into a load, and recharged many times, as opposed to a disposable or primary battery, which is supplied fully charged and discarded after use. Typically, a rechargeable battery includes one or more electrochemical cells, and it accumulates and stores energy through a reversible electrochemical reaction. Several different combinations of electrode materials and electrolytes are used, including lead-acid, zinc-air, nickel-cadmium (NiCd), nickel-metal hydride (NiMH), lithium-ion (Li-ion), lithium iron phosphate (LiFePO4), and lithium-ion polymer (Li-ion polymer).

The reactants in the electrochemical reactions in rechargeable batteries, as for example in a lithium-ion cell are materials of anode and cathode, both of which are compounds containing lithium atoms. During discharge, an oxidation half-reaction at the anode produces positively charged lithium ions and negatively charged electrons. Lithium ions move through the electrolyte, electrons move through an external circuit, and then they recombine at the cathode (together with the cathode material) in a reduction half-reaction. The electrolyte and external circuit provide conductive media for lithium ions and electrons, respectively, but do not partake in the electrochemical reaction. During discharge, electrons flow from the negative electrode (anode) towards the positive electrode (cathode) through the external circuit. The reactions during a discharge operation lower the chemical potential of the cell, so discharging transfers energy from the cell to a load the electric current dissipates its energy, mostly in the external circuit. During a charge operation, these reactions and transports go in the opposite direction: electrons move from the positive electrode to the negative electrode through the external circuit. To charge the cell, the external circuit provides electric energy. This energy is then stored as chemical energy in the cell (with some loss, e.g., due to coulombic efficiency lower than one). Both electrodes allow lithium ions to move in and out of their structures with a process called insertion (intercalation) or extraction (deintercalation), respectively.

The reductions of ions at the cathode, the movement of ions and electrons, and their accumulation on the electrodes are parts of a slow electrochemical process, as the only force moving the ions is the electrical potential between the electrodes. Furthermore, this electrochemical process also creates heat that may cause fires and/or explosions of the battery. To counter that risk, rechargeable batteries generally limit or slow down charging to 80% of their potential capacity and/or apply cooling techniques.

Therefore, there is a long felt need for an enhancement of the charging performance of rechargeable batteries without generating excessive heat to reduce fire risks.

### SUMMARY

An embodiment of the present disclosure provides a rechargeable battery including: a first electrode; a second electrode; an ion transfer medium; and an electric motor; wherein the first and second electrodes are connected by the ion transfer medium that facilitates ion movements between the first and second electrodes; and wherein the first electrode is rotatable and the electric motor is configured to rotate the first electrode during a charge operation to stimulate the movement of ions from the first electrode to the second electrode.

### BRIEF DESCRIPTION OF THE DRAWINGS

FIG. 1 is a diagram of a rechargeable battery with a first rotatable electrode and a second electrode according to an embodiment.

FIG. 2 is a diagram of a rechargeable battery with a first rotatable electrode and at least two second electrodes according to an embodiment.

FIG. 3 is a diagram of a rechargeable battery with a first rotatable electrode and at least two second electrode that have different shapes according to an embodiment.

FIG. 4 is a diagram of a rechargeable battery with a first rotatable electrode and a second rotatable electrode according to an embodiment.

FIG. 5 is a diagram pf a rechargeable battery with a first rotatable electrode and a second electrode configured with an internal electromagnetic field generator according to an embodiment.

FIG. 6 is a diagram pf a rechargeable battery with a first rotatable electrode and a second rotatable electrode configured with an external electromagnetic field generator according to an embodiment.

FIG. 7 is a diagram of a rechargeable battery with a first rotatable electrode connected to an internal motor according to an embodiment.

### DETAILED DESCRIPTION

The description of illustrative embodiments according to principles of the present disclosure is intended to be read in connection with the accompanying drawings, which are to be considered part of the entire written description. In the description of embodiments of the disclosure herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the exemplified embodiments. Accordingly, the disclosure expressly should not be limited to such exemplary embodiments illustrating some possible non-limiting combination of features that may exist alone or in other combinations of features; the scope of the disclosure being defined by the claims appended hereto.

This disclosure describes the best mode or modes of practicing the disclosure as presently contemplated. This description is not intended to be understood in a limiting sense, but provides examples presented solely for illustrative purposes by reference to the accompanying drawings to advise one of ordinary skill in the art of the advantages and construction of the certain embodiments. In the various views of the drawings, like reference characters designate like or similar parts.

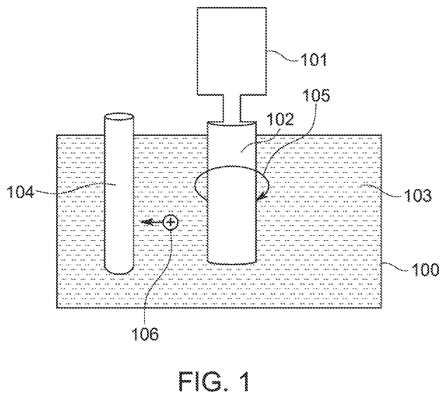

FIG. 1 illustrates a rechargeable battery with a rotatable electrode 102 according to one embodiment. The battery includes a first electrode 102 and a second electrode 104. The electrodes are connected by an ion transfer medium 103 that facilitates movements of ions between first and second electrodes. An electric motor 101 configured to rotate the electrode 102 during a charge operation is attached to the electrode 102 to stimulate the deintercalation of ions at the electrode 102 and the movement of ions between electrodes 102 and 104. The electric motor may couple directly its axle with the rotational axis of the first electrode, or via one or more gears. When the first electrode rotates, ions on the surface of the first electrode experience an apparent centrifugal force, F_{c}=mr ω², where m is the mass of the ion, r is the radius of the first electrode, and ω is the angular rotational speed of the electrode. Thus, by rotating the first electrode, the ions will be accelerated radially away from the rotational axis of the first electrodes, and this action of rotating the first electrode speeds up the transfer of ions between electrodes.

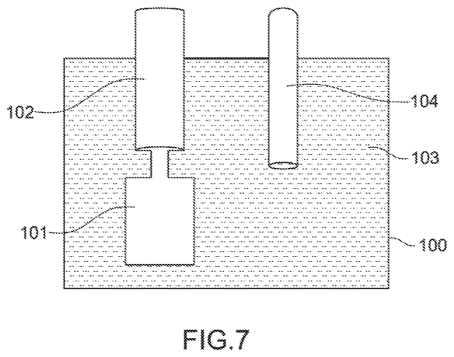

The electric motor 101 may be powered by an external power source or by the battery 100 as a power source itself via lead wires, induction power circuitry or capacitive power circuitry. The electric motor may be placed outside the battery casing 100 in an embodiment, or inside the battery casing 100 as shown in FIG. 7 in another embodiment. During a charge operation, the rotation of the electrode impacts an apparent centrifugal force on the ions, stimulating the deintercalation of the ions at the electrode 102 and the movement of the ions.

The performance of a rechargeable battery in a charge operation is enhanced by rotating the electrode 102 according to one embodiment. As illustrated in FIG. 1, when an external power source (not shown) is connected to the electrodes, electrode 102 releases an ion 106 and the ion 106 moves through the ion transfer medium 103 from the electrode 102 towards the electrode 104 inside the battery. Without any stimulation, the ion 106 moves at a speed just like a standard rechargeable battery, which has many performance issues as discussed above in the background section. When a current is applied to the electric motor 101, the electric motor 101 rotates the electrode 102. The rotation 105 will exert a centrifugal force on the positive charged ion 106, which assists the ion 106 to move from the electrode 102 to the electrode 104.

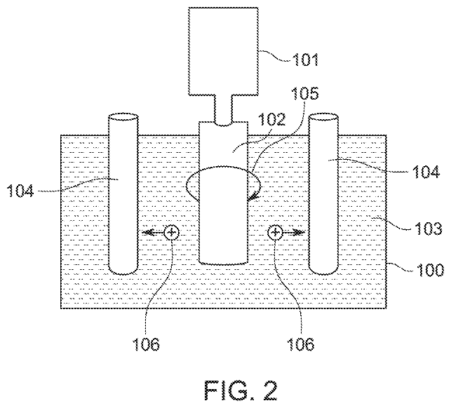

FIG. 2 illustrates a rechargeable battery with a rotating electrode 102 during a charge operation according to one embodiment. The battery includes a first electrode 102 and multiple second electrodes 104. In FIG. 2, only two second electrodes 104 are shown for clarity reasons. The electrodes are connected by an ion transfer medium 103 that facilitates movements of ions between the first electrode and multiple second electrodes. An electric motor 101 configured to spin the electrode 102 during charging is attached to the first electrode 102 to stimulate the deintercalation of ions at the first electrode 102 and the movement of ions among the first and second electrodes. The electric motor 101 may be powered by an external power source or by the battery as a power source itself via lead wires, induction power circuitry or capacitive power circuitry. The electric motor may be placed outside the battery casing or inside the battery casing. Since the centrifugal force, by its nature, is not unidirectional, it might be beneficial to arrange the second electrodes in more than one direction/path from the first electrode, such as in opposing directions from the first electrode, or arranged in a circular formation around the first electrode.

Note that the motor spinning the electrode may be a DC motor (preferably) or an AC motor. It is understood that the engine power, speed of rotation, the timing of the start and termination of the rotation and the variability of the rotation speed is dependent on the characteristics of the electrodes, the transfer medium and the charge status of the battery.

Note that an ion transfer medium can be selected from a wide variety of media that effectively facilitate the movements of ions. For example, the medium is an electrolyte that may be in solid or gel form, e.g., ceramic solid electrolytes, polymer gel electrolytes, or plasticized polymer electrolytes. It is understood that the choice of the medium depends also on the compositions of the electrodes.

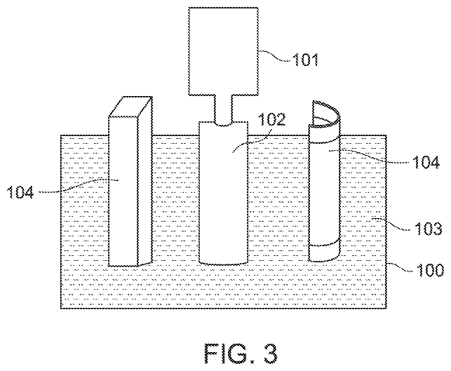

FIG. 3 illustrates that if a higher ratio of surface area to volume that a cylinder shaped anode provides is desired, the electrode(s) 104, the anodes, when not being of rotatable function, may not necessarily be of a cylindrical shape, but can be of a plate having a rectangular or arc shape cross-section according to one embodiment. The shape of the electrodes 104 may be chosen to maximize the coverage of the ions being spun out from the electrode 102.

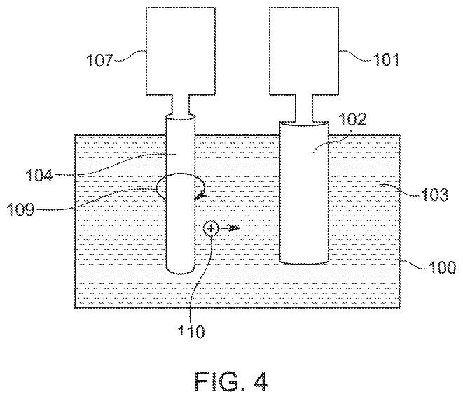

FIG. 4 illustrates a rechargeable battery with two rotating electrodes according to one embodiment. The battery includes a first electrode 102 and a second electrode 104. The electrodes are connected by an ion transfer medium 103 that facilitates movements of ions between first and second electrodes. An electric motor 101 configured to rotate the electrode 102 during a charge operation is attached to the electrode 102 to stimulate the deintercalation of ions at the first electrode and the movement of ions between electrodes. An electric motor 107 is configured to rotate the electrode 104 during the discharge operation to stimulate the reduction of the ions at the second electrode and the movement of the ions between the electrodes. The electric motors 101 and 107 may be powered by an external power source or by the battery as a power source itself via lead wires or induction power circuitry or capacitive power circuitry. The electric motors may be placed outside the battery (preferred) or inside the battery. In one embodiment, a single electric motor can be used to selectively rotate the first and second electrodes by engagements of one or more gears.

In addition to the performance of a rechargeable battery being enhanced during a charge operation as discussed above, the performance of the rechargeable battery during a discharge operation is enhanced by the rotation of the electrode 104 according to one embodiment. Without any stimulation, during discharge operations, the ions 110 move from the second electrode 104 to the first electrode 102 at a speed just like a standard rechargeable battery, which has many performance issues as discussed above in the background section. When current is applied to the electric motor 107 during a discharge operation, the electric motor 107 rotates the second electrode 104. The rotation 109 will exert a centrifugal force on the positive charged ions 110, the force assists the ions 110 to move from the second electrode 104 to the first electrode 102.

In addition to exerting a mechanical force on the ions, the performance of a rechargeable battery may be further enhanced by exerting an electromagnetic force on the ions.

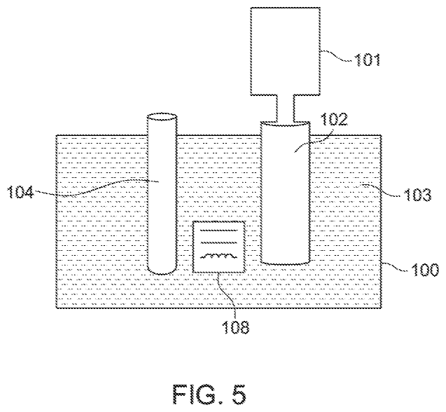

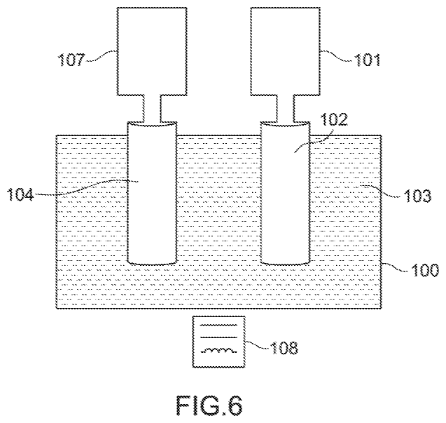

FIGS. 5 and 6 illustrate the application of an electromagnetic field generator 108 to a rechargeable battery according to one embodiment. FIG. 5 illustrates the electromagnetic field generator 108 is integrated into the battery 100, and FIG. 6 illustrates the electromagnetic field generator 108 being external to the battery casing 100.

Note that an electromagnetic field generator may be, for example, an electromagnet. An electromagnet includes a magnetic coil which generates an electromagnetic field when a current passes through the coil. When the current is reversed, the field generated by the electromagnetic generator is reversed. The electromagnet may further include a core made of a high permeability material for concentrating the magnetic field. Also, one or multiple electromagnetic field generators may be used to generate the desired electromagnetic fields. The electromagnetic fields apply a directional force on the ions, stimulating its movement. A skilled person in the art would understand that the interactions of charged particles with electromagnetic field are governed by the Maxwell's equations and Lorentz force equation. The combination of centrifugal force and electromagnetic fields can greatly stimulate the deintercalation of ions at the electrodes and the movement of ions between the electrodes.

Various embodiments of electromagnetic stimulating of the movement of ions have been discussed in U.S. patent application Ser. No. 18/202,482, the contents of which are hereby incorporated by reference.

In one embodiment, the field generator generates an electromagnetic field in a first direction during the charge operation and an electromagnetic field in a second direction during the discharge operation. The directions of the electromagnetic force on the ions are substantially aligned with the directions of ion movements between the electrodes during the respective charge and discharge operations.

In one embodiment, the electromagnetic radiation generator is configured to generate a programmed sequence of electromagnetic fields in concert with a programmed sequence of rotation of one or more electrode. The programmed sequence of electromagnetic fields have characteristics including one or more of: field duration, field strength, field direction, static field, variable field, oscillating field, pulse, and repetition rate, and the programmed sequence of rotations of the one or more electrode have characteristics including one or more of: rotation duration, rotation direction, and rotation speed. The programmed sequences of electromagnetic fields and rotation of one or more electrode may be provided by a controller which controls the electric currents supplied to the electromagnetic field generator and motor respectively.

While the present disclosure describes at some length and with some particularity with respect to the several described embodiments, it is not intended that it should be limited to any such particulars or embodiments or any particular embodiment, but it is to be construed so as to provide the broadest possible interpretation in view of the related art and, therefore, to effectively encompass various embodiments herein. Furthermore, the foregoing describes various embodiments foreseen by the inventor for which an enabling description was available, notwithstanding that modifications of the disclosure, not presently foreseen, may nonetheless represent equivalents thereto.

1. A rechargeable battery, comprising:
a first electrode;
a second electrode;
an ion transfer medium; and
an electric motor;
wherein the first and second electrodes are connected by the ion transfer medium that facilitates ion movements between the first and second electrodes; and
wherein the first electrode is rotatable and the electric motor is configured to rotate the first electrode during a charge operation to stimulate the movement of ions from the first electrode to the second electrode.

2. The rechargeable battery of claim 1, wherein the ion transfer medium is selected from a group comprising: liquid electrolyte, ceramic solid electrolyte, polymer gel electrolyte, plasticized polymer electrolyte, and solid electrolyte interphase (SEI).

3. The rechargeable battery of claim 1, wherein the electric motor is placed outside of a shell of the rechargeable battery.

4. The rechargeable battery of claim 1, wherein the electric motor is placed inside of a shell of the rechargeable battery.

5. The rechargeable battery of claim 1, wherein the electric motor is powered by an external source.

6. The rechargeable battery of claim 1, wherein the electric motor is powered by the rechargeable battery.

7. The rechargeable battery of claim 1, wherein a timing of start and termination, a speed, and/or direction of rotation of the first electrode is adjustable.

8. The rechargeable battery of claim 1, wherein a cross-section of the second electrode is an arc with a radius of curvature centered from an axis of rotation of the first electrode.

9. The rechargeable battery of claim 1, wherein the second electrode is rotatable, and the electric motor or an additional electric motor is configured to rotate the second electrode during a discharge operation to stimulate the movement of ions from the second electrode to the first electrode.

10. The rechargeable battery of claim 1, further comprising at least one additional second electrode to increase a volume of ion transfers among the first electrode, second electrode and at least one additional second electrode.

11. The rechargeable battery of claim 10, wherein the second electrode and at least one second electrode are situated on different sides of the first electrode.

12. The rechargeable battery of claim 1, further comprising an electromagnetic field generator configured to generate a first set of one or more electromagnetic field during the charge operation, and a second set of one or more electromagnetic field during a discharge operation, the first set being different from the second set; wherein the first set of one or more electromagnetic field is configured to exert force on the ions to stimulate the movement of ions from the first electrode to the second electrode, and the second set of one or more electromagnetic field is configured to exert force on the ions to stimulate the movement of ions from the second electrode to the first electrode.

13. The rechargeable battery of claim 12, wherein the electromagnetic field generator is powered by an external source.

14. The rechargeable battery of claim 12, wherein the electromagnetic field generator is powered by the rechargeable battery.

15. The rechargeable battery of claim 12, wherein the electromagnetic field generator is placed outside of a shell of the rechargeable battery.

16. The rechargeable battery of claim 1, wherein the electromagnetic field generator is placed inside of a shell of the rechargeable battery.

17. The rechargeable battery of claim 12, the electromagnetic radiation generator is configured to generate a programmed sequence of electromagnetic fields in concert with a programmed sequence of rotation of the first electrode.

18. The rechargeable battery of claim 17, wherein the programmed sequence of electromagnetic fields have characteristics including one or more of: field duration, field strength, field direction, static field, variable field, oscillating field, pulse, and repetition rate, and the programmed sequence of rotations of the one or more electrode have characteristics including one or more of: rotation duration, rotation direction, and rotation speed.

19. The rechargeable battery of claim 12, wherein the second electrode is rotatable, and the electric motor or an additional electric motor is configured to rotate the second electrode during the discharge operation to stimulate the movement of ions from the second electrode to the first electrode.

20. The rechargeable battery of claim 19, the electromagnetic radiation generator is configured to generate a programmed sequence of electromagnetic fields in concert with a programmed sequence of rotation of the first and second electrodes.
